(19) United States
(12) Patent Application Publication
(10) Pub. No.: US 2025/0307784 A1
(43) Pub. Date: Oct. 2, 2025

(54) POWER TOOL WITH EMBEDDED CALENDAR

(71) Applicant: MILWAUKEE ELECTRIC TOOL CORPORATION, Brookfield, WI (US)

(72) Inventor: Kerry J. Woodbury, Port Washington, WI (US)

(21) Appl. No.: 19/093,019

(22) Filed: Mar. 27, 2025

Related U.S. Application Data
(60) Provisional application No. 63/571,261, filed on Mar. 28, 2024.

(51) Int. Cl. G06Q 10/1093; B25F 5/00; G06Q 10/20

(52) U.S. Cl. CPC G06Q 10/1093; B25F 5/00; G06Q 10/20

(57) ABSTRACT

A power tool includes a tool housing, a motor positioned within the tool housing, and a controller coupled to the motor. The controller is configured to determine a critical date for the power tool and upload the critical date to an embedded calendar of the controller and send an alert to a user indicating when the critical date will occur, wherein the alert further includes an action associated with the critical date.

### CROSS REFERENCE TO RELATED APPLICATIONS

This application claims priority to, and the benefit of, U.S. Provisional Patent Application No. 63/571,261, filed Mar. 28, 2024, the entire contents of which are incorporated by reference herein.

### FIELD OF THE INVENTION

The present invention relates generally to power tools, such as power drills or impact drivers.

### BACKGROUND OF THE INVENTION

Power tools generally need maintenance to keep the power tools in working condition. When a user has an inventory of power tools, the power tools may need maintenance simultaneously. When this occurs, the power tools may require removal from the inventory. Additionally, tools may sometimes be stolen or otherwise removed from a work site without authorization.

### SUMMARY

In some aspects, the technology described herein relates to a power tool including: a tool housing; a motor positioned within the tool housing; and a controller coupled to the motor, the controller configured to: determine a critical date for the power tool and upload the critical date to an embedded calendar of the controller, and send an alert to a user indicating when the critical date will occur, wherein the alert further includes an action associated with the critical date.

In some aspects, the technology described herein relates to a power tool having a tool housing; a motor positioned within the tool housing; and a controller coupled to the motor. The controller is configured to determine a critical date for the power tool and upload the critical date to an embedded calendar of the controller, wherein the power tool is inoperable after the critical date occurs.

In some aspects, the technology described herein relates to a power tool system that includes a first power tool including a first embedded calendar module, a second power tool including a second embedded calendar module, and a calendaring application positioned external from the first power tool and the second power tool. The calendaring application is connected to the first embedded calendar module and the second embedded calendar module, wherein the calendaring application sets a first critical date for the first embedded calendar module, and wherein the calendaring application sets a second critical date for the second embedded calendar module.

Other aspects of the invention will become apparent by consideration of the detailed description and accompanying drawings.

### BRIEF DESCRIPTION OF THE DRAWINGS

FIG. 1 is a perspective view of a tool according to one embodiment of the invention.

FIG. 2 is a side view of the tool shown in FIG. 1 with a portion of a tool housing removed.

FIG. 3 is a schematic view of a control system of the tool of FIG. 1.

FIG. 4 is a front view of an electronic calendar that can be used with the tool of FIG. 1.

FIG. 5 is a front view of the tool of FIG. 1 communicating with an electronic device.

FIG. 6 is a front view of the tool of FIG. 1 communicating with a mesh network.

FIG. 7 is a flow chart illustrating a method for updating a central calendar via a calendaring application.

FIG. 8 is a flow chart illustrating a method for updating an embedded calendar module via a power tool.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

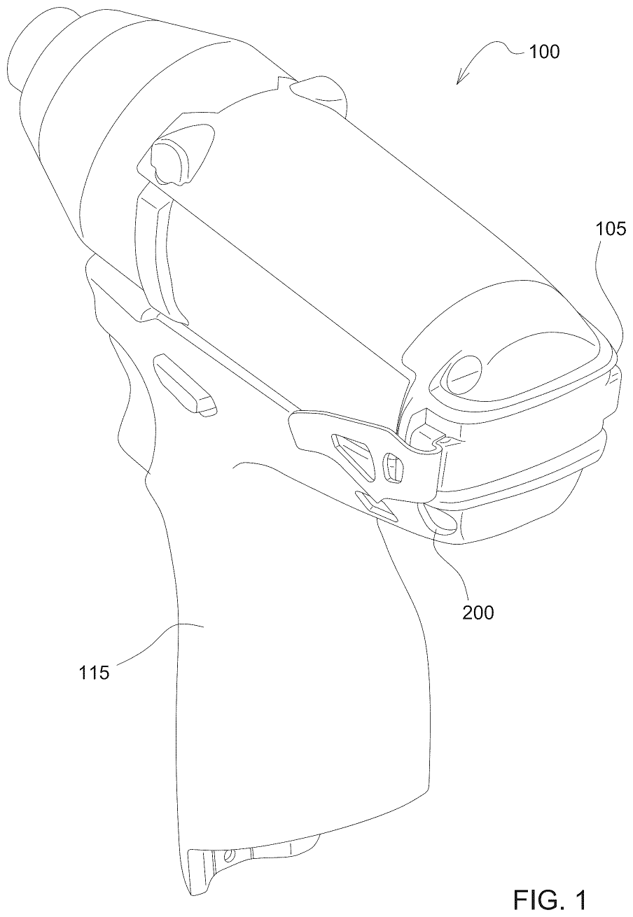

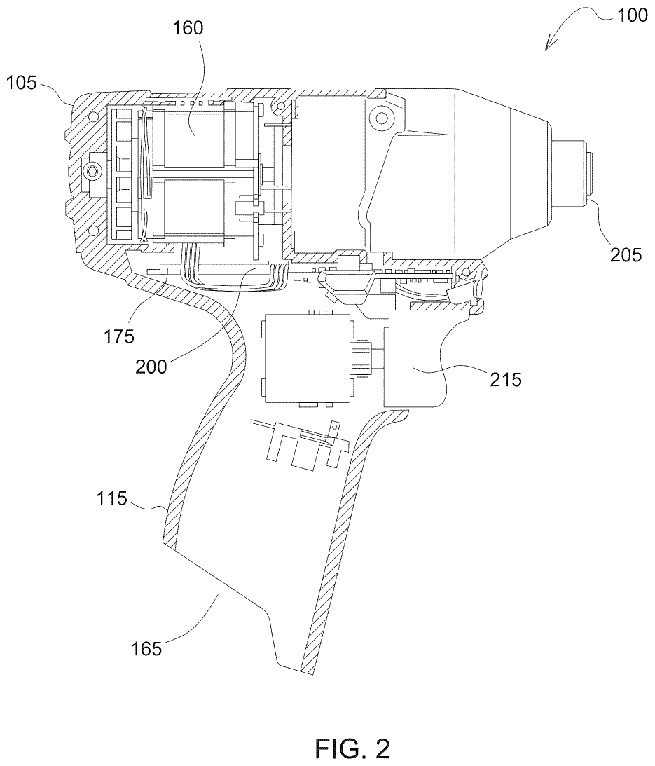

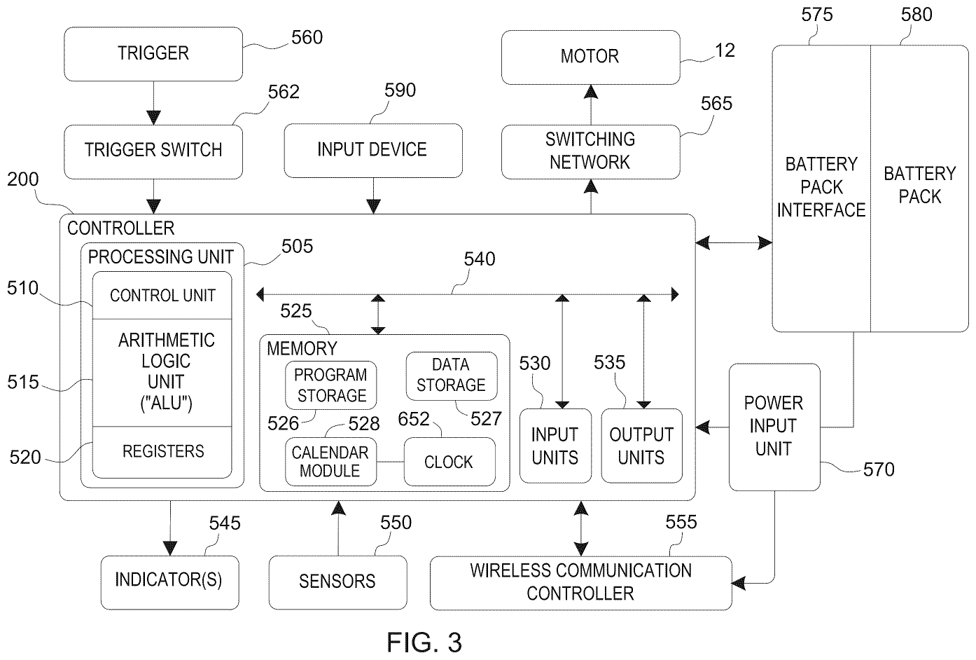

FIGS. 1 and 2 illustrate a power tool 100 (e.g., a power drill, an impact driver, a power saw, an angle driver, or other power tool as required for a given application). In some examples, the power tool 100 may be a battery powered power tool; however, AC power tools or other alternatively powered power tools are also contemplated as required for a given application. The power tool 100 includes a tool housing 105, a motor 160 positioned within the tool housing, and an output spindle driven by the motor 160. The main housing receives a battery receptacle 165 for receiving a battery (not shown). The battery may be a battery pack 580, shown in FIG. 3. The battery pack 580 is configured to supply power to the motor 160 when a user depresses a trigger 215. The trigger 215 is disposed adjacent a gripping region on a main handle. The power tool 100 further includes a PCB 175 electrically coupled to the motor 160 and including electrical and electronic components that are operable to control the power tool 100. In the illustrated embodiment, the PCB 175 includes a controller 200 for controlling operation of the power tool 100.

In one example, the motor 160 may be a multi-speed, brushless direct-current (BLDC) motor. As is commonly known, BLDC motors include a stator, a permanent magnet rotor, and an electronic commutator. The electronic commutator typically includes, among other things, a programmable device (e.g., a microcontroller, a digital signal processor, or a similar controller) having a processor and a memory. The programmable device of the BLDC motor uses software stored in the memory to control the electric commutator. The electric commutator then provides the appropriate electrical energy to the stator in order to rotate the permanent magnet rotor at a desired speed. In some embodiments, the controller acts as the programmable device of the motor 160. In other embodiments, the programmable device is separate from the controller. In other embodiments of the motor 160, the motor 160 can be a variety of other types of multi-speed or variable-speed motors, including but not limited to, a brush direct-current motor, a stepper motor, a synchronous motor, an induction motor, a vector-driven motor, a switched reluctance motor, and/or other DC or AC motors. The motor 160 is used to drive a working element 205 (FIG. 2). In the illustrated embodiment the working element 205 is a drill chuck, but other types of tools, such as angle grinders, saws, etc., will use different working elements.

In some embodiments, the battery is a rechargeable lithium-ion battery. In other embodiments, the battery may have a chemistry other than lithium-ion such as, for example, nickel cadmium, nickel metal-hydride, etc. Additionally or alternatively, the battery may be a non-rechargeable battery. In some embodiments, the battery is a power tool battery including a pack housing containing one or more battery cells and a latching mechanism for selectively securing the battery to the battery receptacle 165. In another embodiment, the battery is mounted externally to the handle 115. In another embodiment, the battery is mounted below the handle 115. In another embodiment, an electrical cord provides power to the power tool 100.

Turning now to FIG. 3, a block diagram illustrating the controller 200 is shown. The controller 200 is electrically and/or communicatively connected to a variety of modules or components of the power tool 100. For example, the illustrated controller 200 is connected to indicators 545, sensors 550, a wireless communication controller 555, a trigger interface 560, a trigger switch 562, a switching network 565, a power input unit 570, and an input device 590.

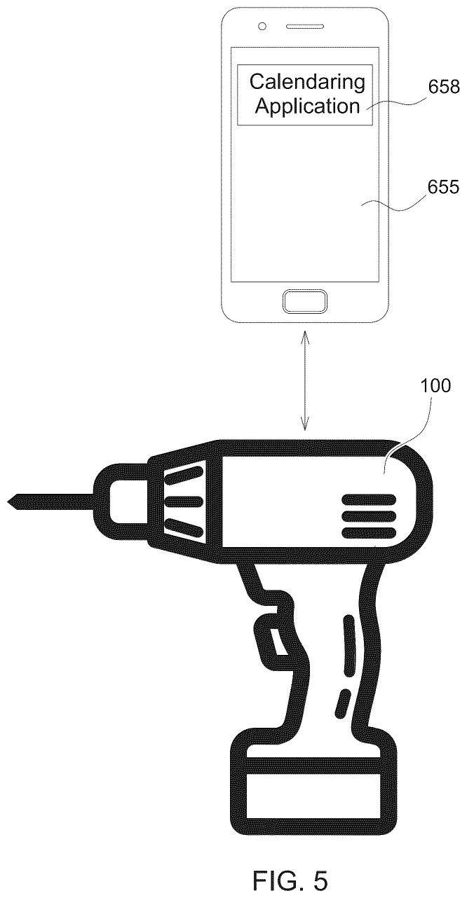

The controller 200 includes a plurality of electrical and electronic components that provide power, operational control, and protection to the components and modules within the controller 200 and/or power tool 100. For example, the controller 200 includes, among other things, a processing unit 505 (e.g., a microprocessor, an electronic processor, an electronic controller, a microcontroller, or another suitable programmable device), a memory 525, input units 530, and output units 535. The processing unit 505 includes, among other things, a control unit 510, an arithmetic logic unit (“ALU”) 515, and a plurality of registers 520 (shown as a group of registers in FIG. 5) and is implemented using a known computer architecture (e.g., a modified Harvard architecture, a von Neumann architecture, etc.). The processing unit 505, the memory 525, the input units 530, and the output units 535, as well as the various modules connected to the controller 200 are connected by one or more control and/or data buses (e.g., common bus 540). The control and/or data buses are shown generally in FIG. 3 for illustrative purposes. The use of one or more control and/or data buses for the interconnection between and communication among the various modules and components would be known to a person skilled in the art in view of the embodiments described herein.

The memory 525 is a non-transitory computer readable medium and includes, for example, a program storage area 526 and a data storage area 527. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 505 is connected to the memory 525 and executes software instruction that are capable of being stored in a RAM of the memory 525 (e.g., during execution), a ROM of the memory 525 (e.g., on a generally permanent basis), or another non-transitory computer readable medium such as another memory or a disc. Software included in the implementation of the power tool 100 can be stored in the memory 525 of the controller 200. The software includes, for example, firmware, one or more applications, program data, filters, rules, one or more program modules, and other executable instructions. In one embodiment, the memory 525 may include an embedded calendar module 528, which will be discuss in more detail below. The controller 200 is configured to retrieve from the memory 525 and execute, among other things, instructions related to the control processes and methods described herein. In other embodiments, the controller 200 includes additional, fewer, or different components.

The battery pack interface 575 is connected to the controller 200 and is configured to receive the battery pack 580. The battery pack interface 575 includes a combination of mechanical (e.g., a battery pack receiving portion) and electrical components configured to and operable for interfacing (e.g., mechanically, electrically, and communicatively connecting) the power tool 100 with the battery pack 580. In one embodiment, the battery pack 580 is similar to the battery described above. The battery pack interface 575 is coupled to the power input unit 570. The battery pack interface 575 transmits the power received from the battery pack 580 to the power input unit 570. The power input unit 570 includes active and/or passive components (e.g., voltage step-down controllers, voltage converters, rectifiers, filters, etc.) to regulate or control the power received through the battery pack interface 575 and to the wireless communication controller 555 and controller 200. When the battery pack 580 is not coupled to the power tool 10, the wireless communication controller 555 may configured to receive power from a back-up power source (e.g., a coin cell battery).

In one embodiment, the wireless communication controller 555 is configured to provide wireless communication between the controller 200 of the power tool 100 and one or more external devices. External devices may include wireless networks, computing devices (e.g., smart phones, laptop computers, tablet computer, smart wearable devices, and/or other computing devices as required for a given application. In one embodiment, the wireless communication controller 555 may be coupled to one or more antennas (not shown) to communicate using various wireless communication protocols. Example wireless communication protocols may include Bluetooth, Bluetooth Low Energy, LoRA, Wi-Fi, WI-Max, Cellular (3G, 4G, 5G, LTE, etc.), RFID, NFC, Zigbee, Z-Wave, and/or other wireless communication protocol as required for a given application.

The indicators 545 are also coupled to the controller 200 and receive control signals from the controller 200 to turn on and off or otherwise convey information based on different states of the power tool 100. The indicators 545 include, for example, one or more light-emitting diodes (LEDs), or a display screen. The indicators 545 can be configured to display conditions of, or information associated with, the power tool 100. For example, the indicators 545 can display information relating to the required actions based on the embedded calendar module. In addition to or in place of visual indicators, the indicators 545 may also include a speaker or a tactile feedback mechanism to convey information to a user through audible or tactile outputs. The input device 590 may be an interface, such as one or more buttons, switches, or other mechanical input means that provide a means of input to the controller 200. In some instances, a user of the power tool 100 may actuate the input device 590 to override a mismatch event, as described below in more detail.

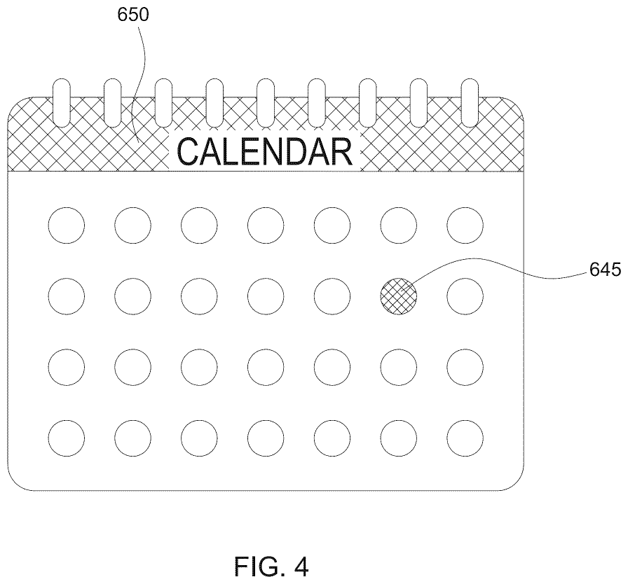

As noted above, the memory 525 of the controller 200 includes an embedded calendar module 528. The embedded calendar module 528 may be configured to schedule critical dates 645 on an electronic calendar 650, such as dates for maintenance, at a time that is most optimal for the user and alerts the user of the upcoming critical date 645 (shown in FIG. 4). In some embodiments, the critical dates 645 may additionally and/or alternatively define one or more lock out dates for the power tool 100 to be out-of-service or inoperable. Where the critical date 645 defines the lock out date, the power tool 100 is inoperable after the critical date 645 occurs. In some examples, the embedded calendar module 528 may include a real time clock 652 to ensure that the embedded calendar module 528 is in sync with the actual date and/or time. The real time clock 652 may include a power source separate from the battery pack 580, such as a coin cell type battery, which allows the real time clock 652 to maintain an accurate time even where the battery pack 580 has been removed and/or has been depleted of energy.

In other examples, the embedded calendar module 528 may receive time and date information from external sources, such as via the wireless communication controller 555. Where the critical date 645 defines the lock out date, the embedded calendar module 528 may communicate with the real time clock 652 to ensure that operation of the power tool 100 is terminated regardless of whether the battery pack 580 is coupled to the power tool 100 to prevent the lock out from being bypassed by an operator removing the battery pack 580.

In some embodiments, the embedded calendar module 528 may be enabled by the user. In other embodiments, the embedded calendar module 528 may be permanently enabled. The embedded calendar module 528 may include the electronic calendar 650 for alerting the user when events, such as preventative maintenance, will occur and when updates for the power tool 100 are available. Specifically, the electronic calendar 650 is embedded in the embedded calendar module 528. The embedded calendar module 528 may be configured to determine critical dates 645 to input into the electronic calendar 650 based on recommendations from a manufacturer. The critical dates 645 may include suggested dates for preventative maintenance. For example, a manufacturer of the power tool 100 may suggest that the user take the power tool 100 into a repair shop for preventative maintenance every two years to maintain the functionality of the power tool 100. The critical date 645 may correspond with the suggested maintenance every two years. However, other maintenance intervals are also contemplated as required for a given application. The electronic calendar 650 is embedded with the suggested days when the preventative maintenance should occur. In some embodiments, a system manager may additionally and/or alternatively set critical dates 645 in the electronic calendar 650. The critical dates 645 may correspond to preventative maintenance, lock out, cleaning, inspections, or the like.

In some embodiments, the embedded calendar module 528 may determine the critical dates 645 based on an inventory of a user. The inventory defines a collection of power tools 100 owned by the user. The embedded calendar module 528 may consider the other power tools 100 in the inventory when the critical dates 645 are set in order to ensure that the critical dates 645 of the power tools 100 are not occurring concurrently. Therefore, only one power tool 100 in the inventory will be scheduled for maintenance on a given day (or other applicable time period based on the required action). For example, the embedded calendar module 528 may schedule a first power tool 100 for maintenance on January 1-5 and a second power tool 100 for maintenance on January 6-10. In other embodiments, the embedded calendar module 528 may not consider the inventory of the user.

In some embodiments, each power tool 100 in the inventory may be added to the inventory when purchased or otherwise obtained by a user. In some examples, the user may communicate with the power tool 100 to add it into the inventory via the wireless communication controller 555. In one example, the wireless communication controller 555 may communicate with one or more external devices related to the inventory of the user, such as an inventory management system. The inventory management system may be configured to maintain a list of tools or other devices in the inventory, as well as to manage the preventative maintenance. Thus, the power tool 100 may be configured to transmit the data within the embedded calendar module 528 to the inventory management system via the wireless communication controller 555. The wireless communication controller 555 may further be configured to receive data from the inventory management system, such as updated maintenance information and/or other updates for the embedded calendar module 528.

In some embodiments, the embedded calendar module 528 may determine critical dates 645 corresponding to the lock out dates of the power tools 100 in the inventory. Once the lock out date occurs, the power tool 100 may be inoperable such that the power tool 100 is disabled from future use. The embedded calendar module 528 may add a critical date 645 corresponding to the lock out date when one of the power tools 100 is checked out from the inventory. For example, the lock out date may be a defined time period such as 8 hours, 24 hours (1 day), one week, and/or various other time periods. In some examples, the lock out date may be set to a date that a given project or task associated with a tool and/or user is to be completed. As noted above, the lock out date may be set via the inventory management system via the wireless communication controller 555. In other examples, the lock out date may be times when a job site is inactive (e.g., weekends, holidays, or the like). In other examples, the user may be able to set the lock out date via the calendaring application 658, as described herein.

By setting the lock out date, the power tool 100 is inoperable after the lock out date occurs, encouraging the power tool 100 to be returned to the inventory. This not only helps to ensure that power tools 100 are promptly returned to inventory, but also helps to prevent theft of the power tool 100 that has been checked out. The lock out date is particularly useful at a worksite when multiple contractors, sub-contractors, and/or workers check out the power tools 100 from the inventory.

When the critical date 645 occurs, the embedded calendar module 528 sends an alert to the user. The alert may be generated externally or locally on the power tool 100, such as via the indicators 545. When the alert is generated externally, the alert may be sent via a push notification on an external electronic device 655, a text message sent to the external electronic device 655, or other notifications as required for a given application. In some embodiments, the external electronic device 655 may be a cellular device (e.g., smartphone); however, it is understood that other external electronic devices may also be used to update the alert settings via the wireless communication controller 555, such as portable computers, desktop computers, cloud computing devices, dedicated tool management devices, and/or other devices as required for a given application.

When the alert is generated locally (e.g., via indicators 545), an indication light may illuminate on the power tool 100, the power tool 100 may emit a sound, or the like. Further, the embedded calendar module 528 may send an alert to the external electronic device 655 indicating that the critical date 645 is upcoming. For example, the embedded calendar module 528 may send the alert when the critical date 645 is two weeks away. In other embodiments, the embedded calendar module 528 may send the alert when the critical date 645 is one month away, one day away, 15 minutes away, or the like. In some embodiments, the user may modify when and/or how the alerts are sent. The user may update alert settings on the user's external electronic device 655. For example, the alert settings may be accessible on a calendaring application 658 on the electronic device 655. The updated alert settings may then be transmitted to the power tool 100 via the wireless communication controller 555. In other embodiments, the user may not be able to change when and/or how the alerts are sent. The alert sent to indicate that the critical date 645 is upcoming may be the same as the alert sent where the critical date 645 has occurred. In other embodiments, the alert sent to indicate that the critical date 645 is upcoming may be different than the alert sent when the critical date 645 has occurred.

In some embodiments, the embedded calendar module 528 may additionally send an alert when a service is required. For example, where a battery life (“state-of-health”) or battery charge (“state-of-charge”) of the battery pack 580 falls below a predetermined level, the embedded calendar module 528 may generate an alert. The embedded calendar module 528 may additionally send alerts when power tools 100 are removed from or returned to the inventory. For example, embedded calendar module 528 may send an alert when the power tool 100 is returned to the inventory. In one embodiment, a user of the power tool 100 may perform one or more actions to generate an indication that the power tool 100 is back in inventory. In other examples, the controller 200 may determine that the power tool 100 is back in inventory based on various parameters, such as location data, connection to a local network, and/or other parameters as required for a given application. The embedded calendar module 528 may additionally send alerts about power tools 100 in the inventory. For example, the embedded calendar module 528 may send an alert when batteries held in the inventory are fully charged and available for use. In other embodiments, the embedded calendar module 528 may send alerts at different and/or alternative times.

In some embodiments, the electronic calendar 650 is solely updated by the user. For example, once the user receives the power tool 100, the user may include additional critical dates 645 for alerts to be sent. The user may add critical dates 645 by accessing the calendaring application 658 on the electronic device 655. The embedded calendar module 528 may then be updated via the wireless communication controller 555. For example, the user may create a critical date 645 corresponding to the lock out date for one of the power tools 100 in the inventory. Once the lock out date occurs, the power tool 100 may be inoperable such that the power tool 100 is disabled from future use. The user may schedule the lock out date when the power tool 100 is checked out of the inventory. In other embodiments, the user may not be able to add the additional critical dates 645.

With reference to FIG. 5, in other embodiments, the embedded calendar module 528 may communicate with the calendaring application 658 on an external device to determine and update the critical dates 645. More specifically, the embedded calendar module 528 may periodically connect to the calendaring application 658 on the electronic device 655. In some embodiments, the embedded calendar module 528 may connect to the calendaring application 658 automatically at predetermined intervals. In other embodiments, the user may manually connect the embedded calendar module 528 to the calendaring application 658. The embedded calendar module 528 may connect to the calendaring application 658 on the electronic device 655 via a Bluetooth connection (such as via the wireless communication controller 555). In other embodiments, the embedded calendar module 528 may connect to the calendaring application 658 on the electronic device 655 through a hardwire connection and/or other wireless connections. When the embedded calendar module 528 connects to the calendaring application 658, the calendaring application 658 may update the critical dates 645 and/or add critical dates 645 based on suggestions from the manufacturer. Specifically, the calendaring application 658 may include a central calendar 665 that is updated as scheduling changes occur. The calendaring application 658 may consider the user's inventory when making scheduling changes. For example, the calendaring application 658 may limit the number of critical dates 645 on one day to prevent multiple power tools 100 from being out of service and/or out of the inventory on the same day.

In response to the embedded calendar module 528 connecting to the calendaring application 658, a copy of the central calendar 665 is saved onto the embedded calendar module 528. In some examples, the calendaring application 658 may only provide data related to the electronic calendar 650 of the specific power tool 100 upon updating the electronic calendar 650. The electronic calendar 650 may be updated with a copy of the most recent central calendar 665 each time the embedded calendar module 528 connects to the calendaring application 658. Therefore, the electronic calendars 650 of the power tools 100 in the inventory are synchronized each time the power tools 100 are all connected to the calendaring application 658.

Additionally, the calendaring application 658 may add critical dates 645 corresponding to updates available for the power tool 100. In some embodiments, when an update is available, the calendaring application 658 may allow the user to download the update to the controller 200 immediately by selecting an input of the calendaring application 658. In other embodiments, the calendaring application 658 may solely update the electronic calendar 650. Additionally, the calendaring application 658 may download information about the power tool 100. For example, the calendaring application 658 may download a state-of-charge level of the battery pack 580, a battery life of the battery pack 580, characteristics of the motor 160, and the like. The calendaring application 658 may display the information to the user via the associated electronic device 655. Additionally, the calendaring application 658 may use the information to schedule additional critical dates 645. For example, where a state-of-charge of the battery pack 580 is at 50% of an initial battery capacity, and/or where the state-of-health of the battery pack 580 has fallen below a threshold (e.g., 50%), the calendaring application 658 may add a critical date 645 on the central calendar 665 for additional maintenance to replace the battery pack 580.

In some embodiments, the calendaring application 658 automatically creates a critical date 645 corresponding to the lock out date once the power tool 100 has been checked out from the inventory. In other words, the calendaring application 658 may create a critical date 645 for a default amount of time after the power tool 100 has been checked out from the inventory. For example, the calendaring application 658 may add a critical date 645 corresponding to the lock out date for eight hours after check-out of the power tool 10. By setting the lock out date, the power tool 100 is inoperable after the lock out date occurs, encouraging the power tool 100 to be returned to the inventory. In other embodiments, the default amount of time after the power tool 100 has been checked out may be less than or more than eight hours.

In use, the user connects the embedded calendar module 528 to the calendaring application 658 on the electronic device 655, such as via the wireless communication controller 555. The calendaring application 658 may receive information from the embedded calendar module 528 upon the connection being established between the controller 200 and the electronic device 655. Based on the information received, the calendaring application 658 updates the critical dates 645 on the central calendar 665, taking into consideration the critical dates 645 of the other power tools 100 in the inventory. The calendaring application 658 uploads a copy of the central calendar 665 to the embedded calendar module 528. The embedded calendar module 528 may disconnect from the calendaring application 658 upon completion of all outstanding actions. The embedded calendar module 528 alerts the user when the critical date 645 will occur.

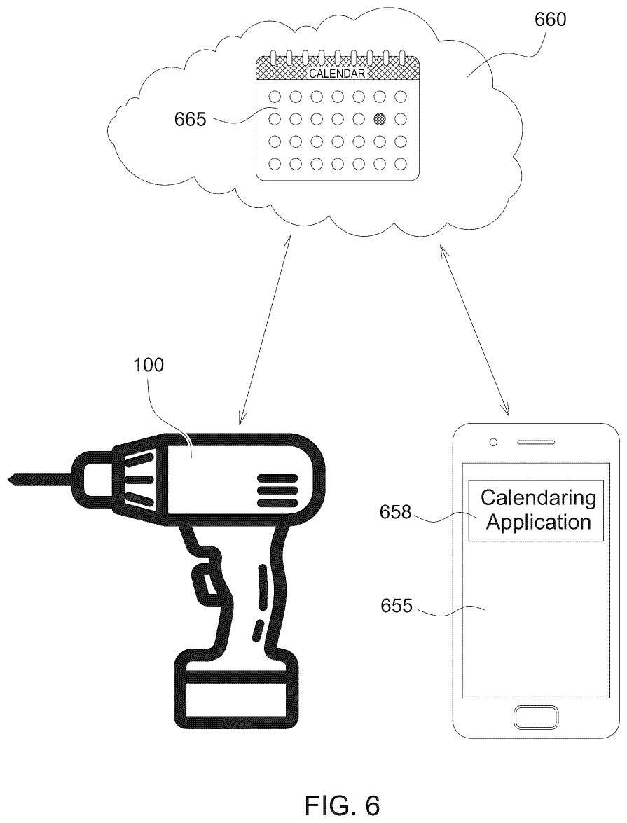

With reference to FIG. 6, the embedded calendar module 528 may communicate with a mesh network 660, or an alternative peer to peer network and/or cloud based network, to determine and update the critical dates 645. Specifically, periodically connecting to a mesh network 660 and/or other networks. In some embodiments, the embedded calendar module 528 may connect to the mesh network 660 automatically. In other embodiments, the user may manually connect the embedded calendar module 528 to the calendaring application 658. When the embedded calendar module 528 connects to the mesh network 660, the mesh network may update and add critical dates 645 based on suggestions from the manufacturer. Additionally, the mesh network 660 may add critical dates 645 corresponding to updates available for the controller. The mesh network 660 includes a central calendar 665 that is updated as scheduling changes occur. The central calendar 665 may consider the user's inventory when making scheduling changes. Therefore, the central calendar 665 may attempt to not schedule multiple critical dates 645 for multiple power tool 100 on one day, as explained above. Once the embedded calendar module 528 connects to the mesh network 660, a copy of the central calendar 665 is saved onto the embedded calendar module 528. Therefore, the electronic calendar 650 defines the copy of the central calendar 665. The electronic calendar 650 is updated with a copy of the most recent central calendar 665 each time the embedded calendar module 528 connects to the mesh network 660. Therefore, the electronic calendars 650 of the power tools 100 in the inventory are synchronized each time the power tools 100 are all connected to the mesh network 660. The mesh network 660 may additionally upload the copy of the central calendar 665 to the calendaring application 658 such that the user can see the central calendar 665. In other embodiments, the mesh network 660 may send the calendaring application 658 to the central calendar 665.

Upon updates of the controller being available for download, the mesh network 660 may send information to the calendaring application 658. The calendaring application 658 may allow the user to download the update to the controller immediately by selecting an input of the calendaring application 658. Additionally, the mesh network 660 may download information about the power tool 100. For example, the mesh network 660 may download a state-of-charge level of the battery pack 580, a state-of-health of the battery pack 580, characteristics of the motor 160, and the like. The mesh network 660 may send this information to the calendaring application 658 such that the user can view the information. Additionally, the mesh network 660 may use the information to schedule additional critical dates 645. For example, where a capacity of the battery pack 580 is at 50% of an initial battery capacity, the mesh network 660 may add a critical date 645 on the central calendar 665 for additional maintenance to replace the battery pack 580.

In some embodiments, the mesh network 660 may automatically create a critical date 645 corresponding to the lock out date once the power tool 100 has been checked out from the inventory. In other words, the mesh network 660 may create a critical date 645 for a default amount of time after the power tool 100 has been checked out from the inventory. For example, the mesh network 660 may add a critical date 645 corresponding to the lock out date for eight hours after the power tool 100 is checked out from inventory. By setting the lock out date, the power tool 100 is inoperable after the lock out date occurs, encouraging the power tool 100 to be returned to the inventory. In other embodiments, the default amount of time after the power tool 100 has been checked out may be less than or more than eight hours.

In use, the user connects the embedded calendar module 528 to the mesh network 660. In one embodiment, the wireless communication controller 555 connects to the mesh network 660 via a Wi-Fi communication protocol. However, in other examples the wireless communication controller 555 may connect to the mesh network using other communication protocols as required for a given application. The mesh network 660 receives information from the embedded calendar module 528. Based on the information received, the mesh network 660 updates the critical dates 645 on the central calendar 665, taking into consideration the critical dates 645 of the other power tools 100 in the inventory. The mesh network 660 uploads a copy of the central calendar 665 to the embedded calendar module 528. The embedded calendar module 528 disconnects from the mesh network 660. The embedded calendar module 528 alerts the user when the critical date 645 will occur.

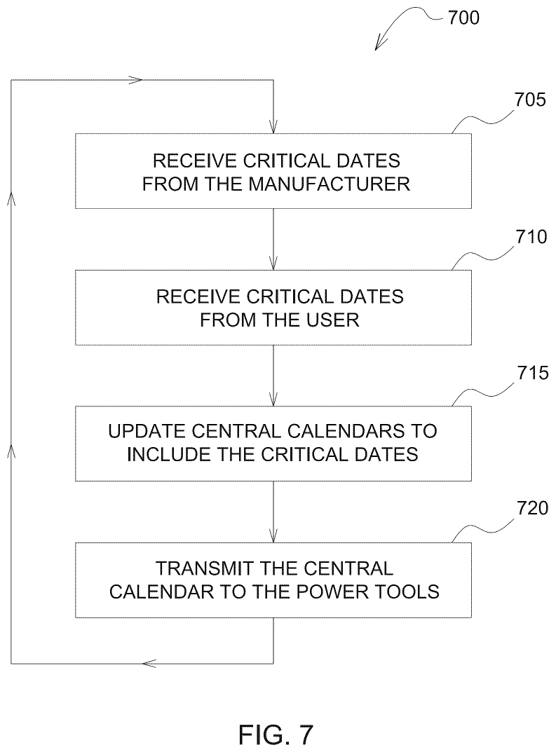

FIG. 7 illustrates a process 700 for updating the central calendar 665 via the calendaring application 658, as explained above. The calendaring application 658 receives critical dates 645 from the manufacturer at process block 705. The calendaring application 658 receives critical dates 645 from the user at process block 710. The calendaring application 658 updates the central calendar 665 to include the critical dates 645 at process block 715. The calendaring application 658 transmits the central calendar 665 to the power tools 100 in the inventory at process block 720. The calendaring application 658 repeats this process while the calendaring application 658 is functional.

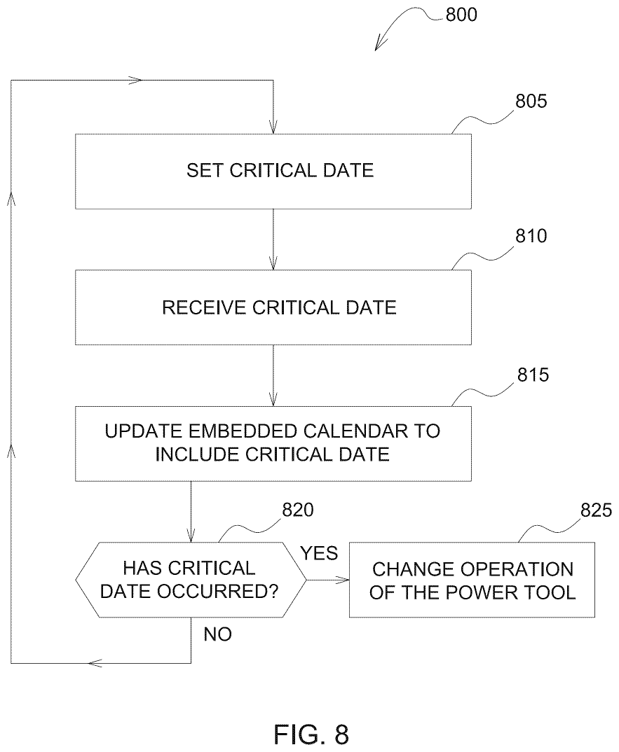

FIG. 8 illustrates a process 800 for updating the embedded calendar module 528 via the power tool 100, as explained above. The critical date 645 is set by the calendaring application 658 or the power tool 100 at process block 805. The power tool 100 receives the critical date 645 at process block 810. Upon receiving the critical step 645, the controller 200 updates the embedded calendar module 528 to include the critical date 645 at process block 815. The controller 200 determines whether the critical date 645 has occurred at process block 820. In response to the critical date 645 being determined to have occurred, the controller 200 changes operation of the power tool 100 at process block 825. For example, the controller 200 may send an alert or stop operation of the power tool 100 in response to the critical date 645 occurring. In response to determining that the critical date 645 has not occurred, the operation of the power tool 100 is not changed. The power tool 100 repeats this process each time a new critical date 645 is set.

One of skill in the art will recognize that embodiments of the invention may be incorporated into tools such as power drills, impact drivers, power saws, angle drivers, and other tools incorporating an embedded calendar module. One skilled in the art will also recognize that Thus, the technology provides, among other things, a power tool including an embedded calendar module for scheduling maintenance of the power tool. Various features and advantages of the invention are set forth in the following claims.

What is claimed is:

1. A power tool comprising:
a tool housing;
a motor positioned within the tool housing; and
a controller coupled to the motor, the controller configured to:
determine a critical date for the power tool and upload the critical date to an embedded calendar of the controller, and
send an alert to a user indicating when the critical date will occur, wherein the alert further includes an action associated with the critical date.

2. The power tool of claim 1, wherein the controller is configured to determine the critical date based on an inventory of the user, and wherein the inventory defines a collection of power tools owned by the user.

3. The power tool of claim 1, wherein the controller is configured to determine the critical date based on power tool performance information, wherein the power tool performance information is at least one of a group consisting of a battery pack state-of-charge and a battery pack state-of-health.

4. The power tool of claim 1, wherein the controller is configured to schedule critical dates on an electrical calendar.

5. The power tool of claim 1, wherein the controller is configured to update the embedded calendar to include additional critical dates by connecting to an application on an external device.

6. The power tool of claim 1, wherein the controller is configured to update the embedded calendar to include additional critical dates by connecting to a mesh network.

7. The power tool of claim 1, wherein the controller is configured to define lock out dates based on the critical date.

8. The power tool of claim 7, wherein the power tool is inoperable on the lock out dates.

9. The power tool of claim 1, wherein the controller is further configured to determine additional critical dates, wherein the additional critical dates do not occur concurrently with the critical date.

10. A power tool comprising:
a tool housing;
a motor positioned within the tool housing; and
a controller coupled to the motor, the controller configured to determine a critical date for the power tool and upload the critical date to an embedded calendar of the controller,
wherein the power tool is inoperable after the critical date occurs.

11. The power tool of claim 10, wherein the controller is further configured to determine lock out dates based on the critical date, wherein the power tool is inoperable on the lock out dates.

12. The power tool of claim 10, wherein the controller is further configured to send an alert locally on the power tool, wherein the alert locally is an indicator on the power tool.

13. The power tool of claim 10, wherein the controller is further configured to send an alert externally, wherein the alert is a push notification on an external electronic device.

14. The power tool of claim 10, wherein the critical date is determined based on maintenance dates, wherein the maintenance dates are stored maintenance dates embedded from a manufacturer of the power tool.

15. A system comprising:
a first power tool including a first embedded calendar module;
a second power tool including a second embedded calendar module; and
a calendaring application positioned external from the first power tool and the second power tool and connected to the first embedded calendar module and the second embedded calendar module,
wherein the calendaring application sets a first critical date for the first embedded calendar module,
wherein the calendaring application sets a second critical date for the second embedded calendar module.

16. The system of claim 15, wherein the first and the second critical dates are lock out dates for the first and the second power tools.

17. The system of claim 15, wherein the first critical date is determined based on a maintenance schedule for the first power tool.

18. The system of claim 15, wherein the first critical date and the second critical date are not concurrent dates.

19. The system of claim 15, wherein the calendaring application includes an inventory management system, wherein the inventory management system is configured to maintain a list of power tools.

20. The system of claim 19, wherein the first power tool is added to the inventory management system via the calendaring application.
